(19) United States
(12) Patent Application Publication
(10) Pub. No.: US 2010/0214894 A1
(43) Pub. Date: Aug. 26, 2010

(54) Optical Medium with Added Descriptor to Reduce Counterfeiting

(75) Inventors: Darko Kirovski, Kirkland, WA (US); Ji Yong Shin, Seoul (KR); Vanessa Testoni, Campinas (BR)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/695,152

(22) Filed: Jan. 27, 2010

Related U.S. Application Data
(63) Continuation-in-part of application No. 12/497,571, filed on Jul. 3, 2009.
Application No. 12/497,571 is a continuation-in-part of application No. 12/389,611, filed on Feb. 20, 2009.

(51) Int. Cl. G11B 19/04

(52) U.S. Cl. 369/53.21; G9B/19.005

(57) ABSTRACT

Functionality is described for reducing the unauthorized reproduction of optical media, such as optical discs of various types. The functionality operates by adding a physical descriptor to an optical medium, forming reference descriptor information based on the descriptor (by reading the descriptor Lᵣ times), producing authenticity information based on the reference descriptor information, and providing the authenticity information to a disc use site via various modes. At the disc use site, the functionality operates by reading the authenticity information and reading the descriptor Lᵥ times (where Lᵥ may not equal Lᵣ). Based on the information that is read, the functionality performs cryptographic analysis and descriptor-based analysis to validate the optical medium. The descriptor can be formed on a closed loop of the optical medium. The functionality also includes provisions for reducing the possibility that unwanted correction is performed, which may interfere with analysis of the descriptor.

This application is a continuation-in-part of U.S. application Ser. No. 12/497,571 ('571), filed on Jul. 3, 2009, entitled “Optical Medium with Added Descriptor to Reduce Counterfeiting,” naming the inventors of Darko Kirovski, et al. This disclosure is also a continuation-in-part of U.S. application Ser. No. 12/389,611 ('611), filed on Feb. 20, 2009, entitled “Optical DNA Based on Non-Deterministic Errors,” naming the inventor of Darko Kirovski. Both of these patent applications ('571 and '611) are incorporated by reference herein in their respective entireties.

### BACKGROUND

Optical discs are often the target of counterfeiting. Optical disks include DVD-type discs, CD-type disks, Blu-Ray discs, and so on. In a typical counterfeiting operation, a counterfeiter obtains an authorized or unauthorized version of digital content, e.g., from an authorized or unauthorized version of a disc which stores that content. The counterfeiter then duplicates the content on a potentially large number of counterfeit discs. Such content may include movies, software, games, etc.

Understandably, the industry remains highly motivated to reduce the counterfeiting of optical discs and other products. In one approach, a manufacturer of a product can add a unique ID to a product. However, such an approach is not always effective. Despite preventative efforts, a counterfeiter can potentially discover the ID and subsequently duplicate it on the counterfeit products.

In general, known anti-counterfeiting techniques may help reduce the unauthorized duplication of products. But there remain unmet challenges in such efforts, and thus ample room for improvement.

### SUMMARY

In one illustrative implementation, a system is described for reducing the counterfeit duplication of an optical medium. The system includes a descriptor printing component that prints a descriptor onto the optical medium, where the descriptor has plural descriptor elements. The descriptor is produced with the aim of providing at least one data-level region having a length that produces indeterminate interpretations when read plural times. The system includes a creation system that reads the descriptor from the optical medium and forms reference descriptor information (f_{ref}) based on the descriptor. The creation system then produces authenticity information based on the reference descriptor information. The creation system provides the authenticity information so that it is available for use at a disc use site.

In one case, the creation system provides the authenticity information in a form that differs from a form used to encode payload data on the optical medium.

According to one illustrative aspect, the creation system provides the authenticity information in human-readable form, barcode form, magnetic form, electromagnetic (e.g., RF) tag form, etc., or some combination thereof

According to another illustrative aspect, the creation system affixes the authenticity information to the optical medium or to an article (e.g., package) associated with the optical medium, or to a combination thereof

According to another illustrative aspect, the creation system provides the authenticity information by adding a reference pointer to at least one of the optical medium or to a package associated the optical medium. Then the creation system adds content associated with the authenticity information to a repository provided by an authenticity agent, the content being accessible based on the reference pointer. Alternatively, the creation system can encode the content associated with the authenticity information directly onto the optical medium or the package, or a combination thereof.

According to another illustrative aspect, the system includes a checking system that processes the optical medium at a disc use site. The checking system includes a code reading component configured to read authenticity information associated with the optical medium from at least one source of authenticity information. This reading operation can be performed using different modes, e.g., in a manner which complements the different modes used by the creation system (summarized above). The checking system also includes an examination component configured to read the descriptor from the optical medium and form in-field descriptor information (f_{field}) based on the descriptor. The checking system also includes a comparison component configured to determine whether the optical medium is valid by, in part, comparing the in-field descriptor information (f_{field})with the reference descriptor information (f_{ref}) obtained from the authenticity information.

According to another illustrative aspect, the examination component is part of an operating environment that is set up to reduce a possibility that unwanted correction is performed in the course of producing the in-field descriptor information (f_{field}) (which can interfere with the integrity of the in-field reference information thus formed). In one mode, the examination component is set up to deactivate at least one processing component that performs unwanted correction. In another mode, the environment is set up to reduce occurrence of a triggering event that will invoke unwanted correction.

According to another illustrative aspect, the examination component is configured to read the descriptor Lᵥ times, wherein the reference descriptor information (f_{ref}) is produced by reading the descriptor Lᵣ times. According to one mode, Lᵥ=Lᵣ. According to another mode, Lᵥ >Lᵣ. According to another mode, Lᵥ<Lᵣ.

According to another illustrative aspect, the descriptor is disposed on a track of the optical medium that forms a closed loop. The examination component is configured to read the descriptor plural times without jumping out of the closed loop.

According to another illustrative aspect, the reference descriptor information (f_{ref}) and the in-field descriptor information (f_{field}) include element type information which indicates whether each descriptor element of the descriptor is one of: a deterministic element, the interpretation of which is biased towards a single value; or a probabilistic element, the interpretation of which is not biased towards a single value.

According to another illustrative aspect, the comparison component is configured to compare the in-field descriptor information (f_{field}) with the reference descriptor information (f_{ref}) by computing a ratio of nₘ to nₚ, where nₚ is a number of probabilistic elements in the reference descriptor information (f_{ref}), and nₘ is a number of probabilistic elements associated with the in-field descriptor information (f_{field}) which match probabilistic elements in the reference descriptor information (f_{ref}).

The above approach can be manifested in various types of systems, devices, components, methods, computer readable media (e.g., discs, etc.), data structures, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an overview of an illustrative system for reducing the unauthorized duplication of an optical medium.

FIG. 2 shows an illustrative optical disc that can be operated on by the system of FIG. 1.

FIG. 3 shows a first way of forming a descriptor on an optical disc, together with a manner of reading the descriptor.

FIG. 4 shows a second way of forming a descriptor on an optical disc, together with a manner of reading the descriptor.

FIG. 5 shows an illustrative output produced by reading data-level regions formed on the surface of an optical disc.

FIG. 6 is a graph which shows an illustrative result of reading a deterministic element L times.

FIG. 7 is a graph which shows an illustrative result of reading a probabilistic element L times.

FIG. 8 is a table which demonstrates one way to construct descriptor information, e.g., f_{ref} or f_{field}.

FIG. 9 shows an illustrative authenticity information creation system that can be used in the system of FIG. 1.

FIG. 10 shows an illustrative descriptor checking system that can be used in the system of FIG. 1.

FIG. 11 shows an illustrative examination component that can be used in the authenticity information creation system of FIG. 7 and the descriptor checking system of FIG. 8.

FIG. 12 is an illustrative decision diagram that shows potentially undesirable correction operations that can be performed in the course of processing code words (produced by reading a descriptor).

FIG. 13 shows an illustrative process for creating authenticity information using the system of FIG. 1.

FIG. 14 shows an illustrative process for validating an optical medium that includes authenticity information added thereto as per the method of FIG. 13.

FIG. 15 shows an illustrative process for reading a descriptor using a closed-loop mode of operation.

FIG. 16 shows an illustrative process for reading a descriptor at a disc creation site and a disc use site, where Lᵣ (the number of times that the descriptor is read at the disc creation site) may differ from Lᵥ (the number of times that the descriptor is read at the disc use site).

FIG. 17 shows an illustrative process for reading a descriptor at different reading speeds.

FIG. 18 shows an illustrative process that aims to suppress unwanted corrections performed in the course of processing code words (produced by reading a descriptor).

FIG. 19 shows illustrative processing functionality that can be used to implement any aspect of the features shown in the foregoing drawings.

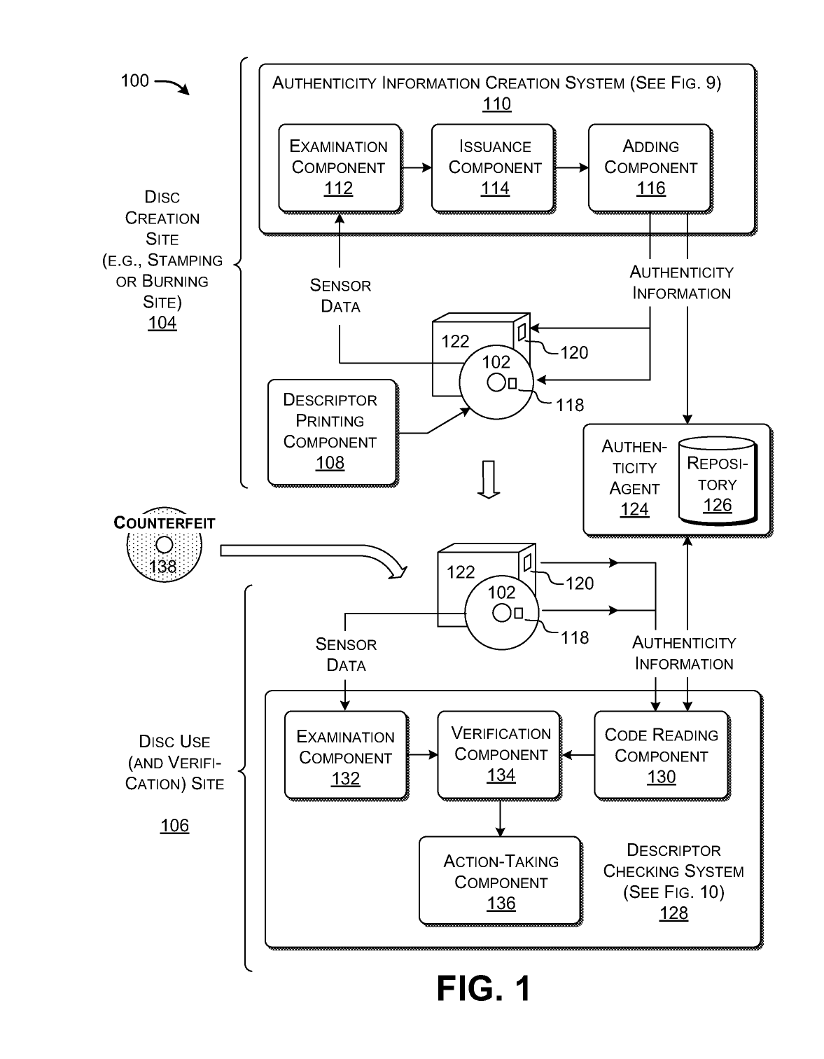

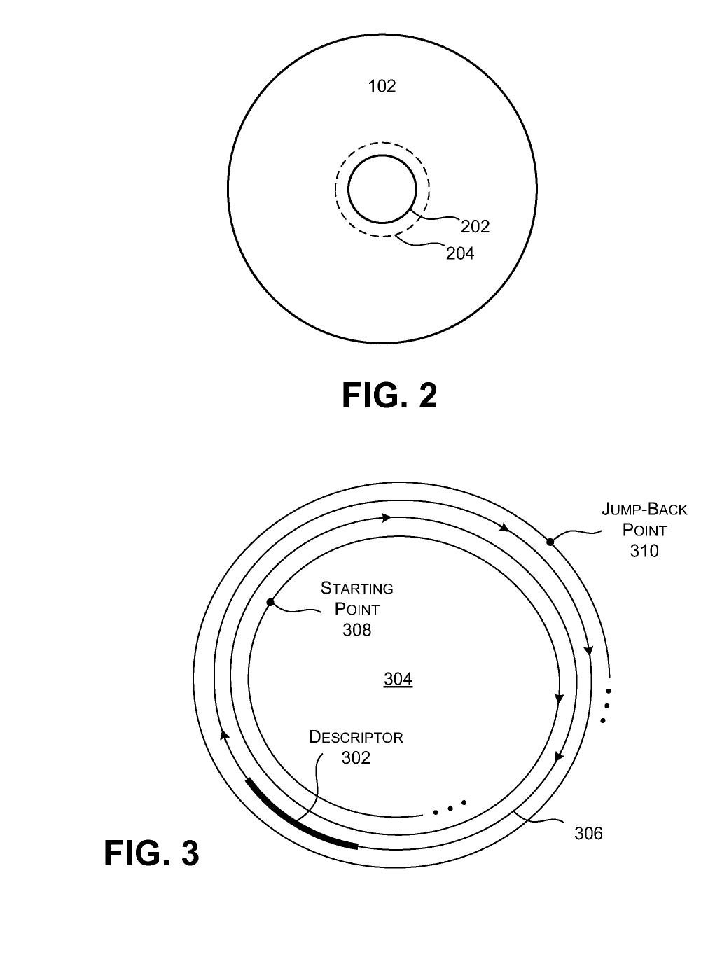

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure sets forth functionality for reducing unauthorized reproduction of optical media, such as optical discs. Section A describes illustrative systems for achieving this result. Section B describes illustrative methods which explain the operation of the systems of Section A. Section C describes illustrative processing functionality that can be used to implement any aspect of the features described in Sections A and B.

In addition to the applications identified in the first paragraph of this disclosure, this application is related to commonly assigned U.S. application Ser. No. 11/689,741 ('741), filed on Mar. 22, 2007, entitled “Optical DNA,” naming the inventors of Kirovski, et al.

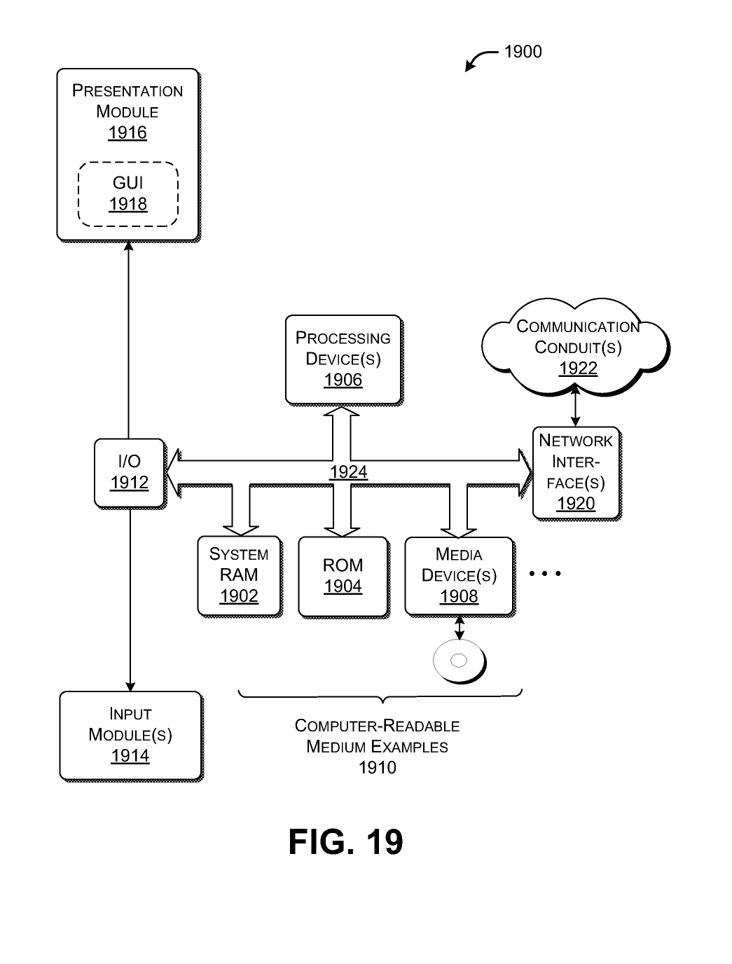

As a preliminary matter, some of the figures describe concepts in the context of one or more structural components, variously referred to as functionality, modules, features, elements, etc. The various components shown in the figures can be implemented in any manner, such as by hardware, software-implemented electrical components, and/or some combination thereof In one case, the illustrated separation of various components in the figures into distinct units may reflect the use of corresponding distinct components in an actual implementation. Alternatively, or in addition, any single component illustrated in the figures may be implemented by plural actual components. Alternatively, or in addition, the depiction of any two or more separate components in the figures may reflect different functions performed by a single actual component. FIG. 19, to be discussed in turn, provides additional details regarding one illustrative implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner.

As to terminology, the phrase “configured to” encompasses any way that any kind of functionality can be constructed to perform an identified operation. The terms “logic” or “logic component” encompass any functionality for performing a task. For instance, each operation illustrated in the flowcharts corresponds to a logic component for performing that operation. When implemented by a computing system (e.g., “computing functionality”), a logic component represents a physical component that is a physical part of the computing system, however implemented.

The following explanation may identify one or more features as “optional.” This type of statement is not to be interpreted as an exhaustive indication of features that may be considered optional; that is, other features can be considered as optional, although not expressly identified in the text. Similarly, the explanation may indicate that one or more features can be implemented in the plural (that is, by providing more than one of the features). This statement is not be interpreted as an exhaustive indication of features that can be duplicated. Finally, the terms “exemplary” or “illustrative” refer to one implementation among potentially many implementations.

A. Illustrative Systems

A.1. Overview

FIG. 1 shows an illustrative system 100 for reducing the unauthorized duplication of a recording medium. In one case, the recording medium corresponds to an optical recording medium in the form of an optical disc. For example, the optical disc can be produced according to any DVD-related standard, any CD-related standard, the Blu-Ray standard, and so on. In another case, the optical medium can take other forms, such as an optical card, etc. However, to facilitate discussion, the remaining explanation will be framed in the context of anti-counterfeiting measures applied to optical discs. FIG. 1 shows one such illustrative optical disc 102.

The optical disc 102 can store any type of content, such as, but not limited to, video content (e.g., a movie), software content, game-related content, data content (e.g., financial tables, etc.), and so on, or any combination thereof Section A.2 below will provide additional explanation of the physical characteristics of the optical disc 102, as these characteristics relate to the anti-counterfeiting provisions employed by the system 100.

The system 100 can operate at two sites. A disc creation site 104 is a locale at which an optical disc 102 is created, at least in part. For instance, in one case, the disc creation site 104 corresponds to a site at which a large number of non-recordable optical discs are produced, e.g., in a conventional stamping process. Alternatively, the disc creation site 104 corresponds to a site at which a user or other entity burns content onto a recordable optical disc. Still other interpretations and implementations of the disc creation site 104 are possible.

A disc use site 106 is any locale at which the optical disc 102 is read or otherwise consumed. For example, the disc use site 106 is the site at which a user loads the optical disc 102 into a player device and attempts to access the content on the optical disc 102, e.g., to watch a movie, play a game, load a software program, etc. Still other interpretations and implementations of the disc use site 106 are possible. The disc use site 106 is also referred to herein as the disc verification site, meaning that this is the site where a user or entity verifies whether the optical disc 102 is authentic.

In one case, the disc creation site 104 is different from than the disc use site 106; further, these two sites (104, 106) can use distinct functionality. In another case, the disc creation site 104 can at least partially overlap the disc use site 106; further, these two sites (104, 106) can share at least some functionality. For example, the disc creation site 104 can make use of a device with disc-burning capability. After the content has been added to the disc, the user can access the content using the same device. Thus, such a device implements parts of both the disc creation site 104 and the disc use site 106.

The disc creation site 104 includes a descriptor printing component 108. The descriptor printing component 108 adds one or more physical descriptors to the optical disc 102. At this juncture of the explanation, assume that the descriptor printing component 108 adds a single descriptor to the optical disc 102.

The descriptor corresponds to a physical data-bearing feature of the optical disc 102. In one example, the descriptor uses lands and pits formed on the surface of the optical disc 102 to represent binary data, e.g., 1's and 0's. These lands and pits are generically referred to as data-level regions herein. The next section will explain the physical characteristics of the descriptor in detail. At this point, suffice it to say that the descriptor includes a plurality B of descriptor elements. Together, these descriptor elements can be metaphorically considered as a “fingerprint” of the optical disc.

Like a fingerprint, the descriptor for each optical disc is unique. More specifically, in one implementation, the descriptor printing component 108 operates with the objective of producing descriptor elements having lengths that produce indeterminate interpretations when read plural times; these lengths are generally referred to as indeterminacy-inducing lengths (to be explained below). Yet due to the difficulty of controlling the printing process on a fine-grained level, the descriptor printing component 108 produces descriptor elements that diverge from the desired length by slight amounts. Each optical disc includes descriptor elements which vary from the specified length in a unique way. This characteristic establishes the uniqueness of the descriptor printed on each optical disc.

In the case in which the optical disc 102 is produced by a stamping process, the descriptor printing component 108 corresponds to whatever manufacturing component stamps the optical disc 102. In other words, the descriptor is just another piece of data stamped onto the optical disc 102 by the stamping process. In the case in which the optical disc 102 is produced by a content-burning process, the descriptor printing component 108 corresponds to whatever player component burns content onto the optical disc. In other words, the descriptor is just another piece of data burned onto the optical disc 102 by the burning process. Still other approaches can be used to create the descriptor on the optical disc 102. To summarize, in one implementation, the descriptor printing component 108 adds the descriptor to the optical disc 102; further, the descriptor printing component 108 attempts to produce descriptor elements having indeterminacy-inducing lengths (to be described below in Section A.2).

In another implementation, the content of the optical disc 102 (e.g., the payload data of the optical disc 102) includes a number of naturally occurring errors. In this case, a descriptor may represent a subset of these naturally occurring errors, some of which may possess indeterminacy-inducing lengths. In another implementation, a descriptor may represent both purposely-created descriptor elements and naturally occurring descriptor elements.

The disc creation site 104 also includes an authenticity information creation system 110 (referred to as a “creation system” 110 for brevity below). The creation system 110 includes an examination component 112, an issuance component 114, and an adding component 116. The examination component 112 reads the descriptor that is formed on the optical disc 102 to produce reference descriptor information (f_{ref}). The reference descriptor information represents the characteristics of the descriptor in a manner which will be described below. The issuance component 114 can cryptographically sign the reference descriptor information to provide authenticity information. Later sections provide additional explanation of one implementation of the examination component 112 and the issuance component 114.

The adding component 116 makes the authenticity information available to the disc use site 106. In one case, the adding component 116 can provide the content of the authenticity information itself, which, as will be described, can include the encrypted reference descriptor information (f_{ref}) and other information. In another case, the adding component 116 can provide a reference pointer that points to the authenticity information. The disc use site 106 can then use the reference pointer to retrieve the content of the authenticity information. In the following discussion, unless otherwise noted, the term authenticity information is used to in a generic sense to encompass either the actual content of the authenticity information or a reference pointer that points to the content, or both. Semantically, the term authenticity information refers to any information that is used to authenticate the optical disc 102.

According to a first mode of operation, the adding component 116 can print the authenticity information onto optical disc 102 itself in the same manner as the payload data, e.g., by creating lands and pits along a spiral track. In the case of a content-burning operation, the adding component 116 can add the authenticity information at any prescribed region of the optical disc 102 in the course of burning the content onto the optical disc 102. Again, in this case, the descriptor is treated like any other data that is added to the optical disc 102. In the case of a stamping operation, the adding component 116 can add the authenticity information to a designated region that can accommodate the storage of data after the stamping process. Technology exists in the marketplace for conducting post-stamping storage. One such technology is Postscribed ID™, provided by Sony Corporation of Minato, Tokyo, Japan. In one case, the post-stamping storage is akin to a content-burning operation, but applied to only the designated region of the optical disc 102.

In a second mode of operation, the adding component 116 can provide the authenticity information as a tag 118 that is affixed to the optical disc 102. (Herein, “affixed” means any way of associating information with a substrate.) The adding component 116 can create the tag 118 using a different mechanism compared to that used to form the payload data. For example, the adding component 116 can encode the authenticity information as a magnetic tag. Alternatively, or in addition, the adding component 116 can provide the authenticity information as a barcode tag. For example, the adding component 116 can add the barcode tag to the optical disc 102 in a bust cutting area (BCA) of the optical disc 102, e.g., using a laser or other barcode forming mechanism. Alternatively, or in addition, the adding component 116 can encode the authenticity information using an electromagnetic tag (e.g., a radio frequency tag). Alternatively, or in addition, the adding component 116 can print the authenticity information (such as a reference pointer) in a human-readable form, e.g., using a marking substance of any type (e.g., ink), an etching operation, an embossing or stamping operation, etc. Still other mechanisms (and combinations of mechanisms) can be used to encode the authenticity information.

In a third mode of operation, the adding component 116 can provide the authenticity information as a tag 120 that is affixed a package 122 associated with the optical disc 102. The term package has broad scope as used herein; it encompasses any article that is associated with the optical disc 102 but separate from the optical disc 102. In one case, the package 122 may correspond to part of a carrier in which the optical disc 102 is provided to the user. Alternatively, or in addition, the package 122 may correspond to a certificate of authenticity or the like (or any other article) which accompanies the optical disc 102. The adding component 116 can form the authenticity information in any form described above (or any combination of forms) to create the tag 120, such as magnetic form, barcode form, RF form, human-readable form, and so on. The adding component 116 can also store the authenticity information on both the optical disc 102 and the package 122.

As stated, the authenticity information can include either the content of the authenticity information or a reference pointer that points to the content (or both). In the latter scenario (in which a reference pointer is provided), the adding component 116 can also send the content of the authenticity information to an authenticity agent 124, which maintains a repository 126 of such authenticity information. In one case, the authenticity agent 124 can correspond to a local or remote server computer (or collection of such computers) which maintains the authenticity information in one or more databases. The authenticity agent 124 also stores the association between reference pointers and authenticity information content, such that that the content can be retrieved based on the reference pointers.

Now turning attention to the disc use site 106, that functionality includes a descriptor checking system 128 (referred to below for brevity as a “checking system” 128). The checking system 128 includes a code reading component 130, an examination component 132, a verification component 134, and an action-taking component 136. The code reading component 130 reads the authenticity information that was provided by the adding component 116. As described above, the adding component 116 can provide the authenticity information according to various modes; hence, the code reading component 130 can likewise read the authenticity information using various modes in a complementary manner. In one case, the code reading component 130 reads the contents of the authenticity information from either the optical disc 102 or the package 122, or both. In another case, the code reading component 130 reads a reference pointer from the optical disc 102 or the package 122, or both, upon which it accesses the content of the authenticity information from the authenticity agent 124 (using the reference pointer as a lookup key). The creation system 110 and the checking system 128 can interact with the authenticity agent 124 using any communication mechanism, such point-to-point links, a local area network, a wide area network (e.g., the Internet), or any combination thereof

The code reading component 130 can read the tags (118 and/or 120) in any manner. In one case, the code reading component 130 uses the same optical reader technology to read both the tags (118 and/or 120) and the normal payload data. Alternatively, or in addition, the code reading component 130 can use any of a magnetic reading mechanism, a barcode reading mechanism, an RF reading mechanism, etc., to read the tags (118 and/or 120), e.g., depending on the nature of the tags (118 and/or 120). (In the case of barcode information provided in the burst cutting area (BCA), according to one option, a same laser that is used to read lands and pits associated with the payload data can also be used to read the barcode information.) Alternatively, or in addition, the code reading component 130 can rely on manual operations performed by a human user to read the tags (118 and/or 120). For example, the code reading component 130 can request the user to type in a reference pointer code presented in human-readable form by the tags (118 and/or 120). Or the code reading component 130 can request the user to take a digital picture of a barcode tag and submit that picture to the authenticity agent 124. Still other approaches can be used to read the information from the tags (118 and/or 120).

Based on authenticity information that is read, the code reading component 130 can obtain the reference descriptor information (f_{ref}) that was generated by the creation system 110. The examination component 132 operates in a similar manner to the examination component 112 of the creation system 110. Namely, the examination component 132 repeatedly reads the physical descriptor that has been added to the optical disc 102. In this context, the examination component 132 produces in-field descriptor information (f_{field}).

The verification component 134 determines whether the optical disc 102 is valid based on two types of tests. First, the verification component 134 performs analysis on the authenticity information to determine whether the optical disc 102 is cryptographically valid (in a manner to be described below). If this test is passed, the verification component 134 performs a descriptor-validation test to determine whether the reference descriptor information (f_{ref}) matches the in-field descriptor information (f_{field}) within an acceptable tolerance. If these two tests indicate that that the optical disc 102 is valid, then the verification component 134 pronounces the optical disc 102 as valid as a whole. The action-taking component 136 performs any type of action based on the decision made by the verification component 134. For example, the action-taking component 136 can enable or disable access to the content provided by the optical disc 102. The action-taking component 136 can also send notifications to appropriate entities (e.g., a publisher entity) regarding the decision made by the verification component 134, and so on. Later sections provide additional explanation regarding various components of the checking system 128.

In the above description, it was assumed that the optical disc 102 processed in the disc creation site 104 is the same optical disc 102 that is processed at the disc use site 106. In this case, the reference descriptor information will presumably match the in-field descriptor information (within an acceptable tolerance), and the verification component 134 will presumably pronounce the optical disc 102 as valid. But next assume that a counterfeit optical disc 138 is produced in an unauthorized manner. In this process, the counterfeiter may attempt to copy both the content on the optical disc and the accompanying descriptor. For the reasons described in detail below, a counterfeiter will have great difficulty reproducing the descriptor on the counterfeit optical disc 138 with sufficient accuracy such that f_{ref} will match f_{field} (at least in a manner inexpensive enough to justify the counterfeiting effort). As such, for this counterfeit optical disc 138, the reference descriptor information will not match the in-field descriptor information, and the verification component 134 will pronounce this counterfeit optical disc 138 as being invalid. Moreover, the cryptographic protection provided by the system 100 provides another hurdle for a potential counterfeiter to overcome.

The system 100 thereby provides a substantially tamper-proof method for discriminating genuine products from counterfeit products. Armed with such knowledge, merchants and end-users are empowered to identify and reject counterfeit products. Publishers and other entities are also more effectively apprised of the existence of counterfeit products, and may take appropriate action on the basis of this knowledge.

A.2. Illustrative Descriptor and Manner of Providing the Descriptor on an Optical Disc

Having presented an overview of the system 100, the ensuing section describes the physical characteristics of the optical disc 102 and the descriptor. This section will also explain the relevance of the physical characteristics of the descriptor with respect to the operation of the system 100 as a whole. In one example, the optical disc 102 conforms to the DVD standard specified in ECMA-267 (“120 mm DVD—Read-Only Disk,”3^{rd} edition, 2001). However, the principles described herein can be implemented using optical media that conform to other standards.

FIG. 2 shows one implementation of the optical disc 102. The optical disc 102 is circular in shape and includes a center hole 202. The optical disc 102 provides a spiral path (not shown in FIG. 2) on which digital content can be encoded.

In one case, the descriptor printing component 108 (of FIG. 1) can print the descriptor at a predetermined location on the optical disc 102. For example, the descriptor printing component 108 can add the descriptor in a region 204 of the optical disc 102 that has traditionally been used to store the table of contents for the optical disc 102. For example, the descriptor printing component 108 can print the descriptor before or after data associated with the table of contents. In this manner, the descriptor will not interfere with payload data associated with the primary content carried by the optical disc 102. Other implementations can store the descriptor at other locations on the optical disc 102. Further, the descriptor printing component 108 can print plural descriptors onto the optical disc 102, possibly in different respective regions of the optical disc 102. Further, as stated, the descriptor may be alternatively (or additionally) composed of naturally-occurring errors in the data encoded on the optical disc 102; in that case, the descriptor may be interspersed within (and a part of) the payload data of the optical disc 102.

FIG. 3 shows a first manner of forming a descriptor 302 on an optical disc 304 and then reading that descriptor 302. Here, the descriptor printing component 108 prints at least one descriptor (e.g., descriptor 302) on a spiral track 306 of the optical disc 304, in a designated region. The examination component 112 of the creation system 110 reads the descriptor 302 by first moving to a starting point 308 on the track 306, which represents a point on the track 306 that is prior to the descriptor 302 (with respect to how the optical disc 304 is read). The examination component 112 then reads information along the track 306 as the optical disc 304 rotates; through this process, the examination component 112 will eventually read the descriptor 302. As will be described, the reference field information f_{ref} is formed by reading the descriptor 302 multiple times. Accordingly, upon reaching some jump-back point 310, the examination component 112 jumps back to the starting point 308 (or some location thereabout). The examination component 112 then reads the descriptor 302 a second time. The examination component 112 repeats this procedure for Lᵣ iterations, after which it computes the reference field information f_{ref}. The examination component 132 of the checking system 128 functions in the same manner described above, reading the descriptor Lᵥ times at the disc use site 106 to form f_{field}.

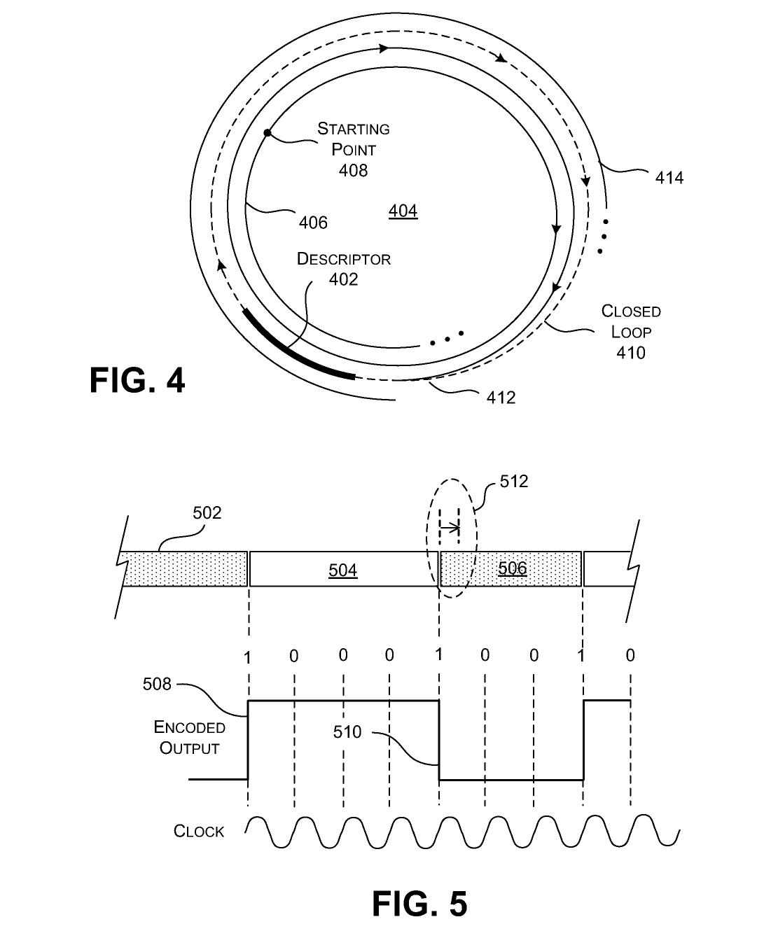

FIG. 4 shows a second manner of forming a descriptor 402 on an optical disc 404 and then reading that descriptor 402. Here, the descriptor printing component 108 again prints at least one descriptor (e.g., descriptor 402) on a spiral track 406 of the optical disc 404. The examination component 112 of the creation system 110 reads the descriptor 402 by again moving to a starting point 408 on the track 406, which represents a point on the track 406 that is prior to the descriptor 402 (with respect to how the optical disc 404 is read). The examination component 112 then reads information along the track 406 as the optical disc 404 rotates; through this process, the examination component 112 will eventually read the descriptor 402. In this scenario, note that the descriptor printing component 108 prints the descriptor 402 on a portion of the track 406 that forms a closed (repeating) loop 410 (which is drawn in dashed lines for emphasis). In other words, the track 406 transitions to a closed loop 410 at transition point 412 on the track 406. By virtue of this feature, the examination component 112 will repeatedly read the descriptor 402 as the optical disc 404 rotates, without having to jump back to the starting point 408. The examination component 112 can be configured to jump out of the closed loop 410 once it reads the descriptor 402 a desired number Lᵣ of times. For example, the examination component 112 can jump out to a jump-out point 414, which is part of a spiral track on which payload data or some other data is formed. The examination component 132 of the checking system 128 functions in the same manner described above, reading the descriptor Lᵥ times at the disc use site 106 to form f_{field}.

The implementation of FIG. 4 may have at least one advantage over the implementation of FIG. 3. Namely, in the arrangement of FIG. 4, the examination components (112, 132) can read the descriptor 402 more times in a given time interval compared to the arrangement of FIG. 3. This is because the examination components (112, 132) are not instructed to repeatedly jump back to the starting point 408; therefore the examination components (112, 132) do not consume time performing this step. This characteristic in turn, can improve the quality of the descriptor information (f_{ref}, f_{field}) that is formed on the basis of the reading operation. This is because the descriptor reference information becomes statistically more robust, and hence, more accurate, as the number of reading iterations increases.

In either scenario (FIG. 3 or FIG. 4), the number of times (Lᵣ) that the examination component 112 of the creation system 110 reads a descriptor can differ from the number of times (Lᵥ) that the examination component 132 of the checking system 128 reads the descriptor. For example, in one case Lᵣ>Lᵥ. In another case, Lᵣ<Lᵥ. But in another case, Lᵣ=Lᵥ. For example, in one environment, it may be deemed desirable to expedite the verification of the optical disc 102 at the disc use site 106. In this case, it may be appropriate that Lᵣ<Lᵣ, meaning that the descriptor is read more times at the disc creation site 104 than the disc use site 106. Here, the quality of the in-field descriptor information is selectively boosted by performing more reading iterations (Lᵥ) at the disc use site 106. In other environment, it may be deemed desirable to streamline the manufacturing process; here, improved robustness can be achieved by increasing Lᵥ relative to Lᵣ.

As will be described in Section B, the checking system 128 can also read the descriptor at differing playing speeds to help counteract any bias in the normal playing speed of the checking system 128.

Advancing to FIG. 5, this figure shows a portion of a descriptor 502. From a high-level perspective, the descriptor 502 includes a sequence of data-level regions having two different data levels, in other words, lands and pits. Data-level region 504 corresponds to a data-level region associated with a first data level, while data-level region 506 corresponds to a data-level region associated with a second data level. Each descriptor 502 includes plural (B) descriptor elements, and each descriptor element may itself include plural data-level regions.

FIG. 5 also shows an output produced when the examination components (112, 132) read the descriptor 502, e.g., by projecting a laser onto the surface of the optical disc 102 and measuring the reflectance of the laser by the surface in conventional fashion. In one implementation, the output conditions a raw sensor signal to conform to the non-return-to-zero-inverted (NRZI) format, as driven by a clock. Here, the output exists in a high state or low state depending on whether the laser is reading from the first data-level region or the second data-level region of the optical disc 102. Further, the examination components (112, 132) produce a 1 when there is a transition between states, either high to low or low to high. The examination components (112, 132) assign 0's to clock cycles between consecutive 1's.

In the case of normal payload data, the printing process forms data-level regions that are most suited to provide a desired interpretation when read and decoded. For example, stated in general terms, if the payload data represents a symbol “a,” the descriptor printing component 108 will aim at producing data-level regions having lengths which will yield the desired interpretation when read and decoded—namely, symbol “a.” However, various aberrations can occur during manufacture of the optical disc 102, causing some of the lengths to diverge from their intended lengths.

As a result of these aberrations, the examination components (112, 132) can possibly produce incorrect interpretations of payload data.

In the system of FIG. 1, in one mode, the descriptor printing component 108 can deliberately print a descriptor with deviant lengths. More specifically, the descriptor printing component 108 can print each descriptor element such that, when it is read L times, it yields an inconclusive or indeterminate interpretation. For example, a descriptor element can be formed such that it is interpreted as symbol “a” in some cases and symbol “b” in other cases, with no significant bias in interpretation (where the concept of significant bias is explained in greater detail below). To achieve this effect, the descriptor printing component 108 can deliberately produce data-level region lengths which induce such indeterminacy. Such a length is referred to as indeterminacy-inducing length or slicing length (λ_{T}). In some environment-specific cases, a single descriptor element can include one such indeterminacy-inducing length; in other cases, it may include plural such lengths.

For example, consider the data-level region 504 demarcated by state transition 508 and state transition 510. Assume that this data-level region 504 forms at least part of a descriptor element. In a traditional case, it may be desirable to produce the data-level region 504 such that a sensor signal produced thereby spans four clock cycles. In the present case, the intent is to produce the data-level region 504 having a length that induces indeterminacy when read. FIG. 5 graphically illustrates this concept using an arrow 512 which extends from the data-level region 504. The specific indeterminacy-inducing length which produces the desired “indecisiveness” in interpretation can be empirically determined for a particular environment; it may depend on a host of factors, such as the nature of the symbols which are selected to induce indeterminacy, the nature of the reading equipment used to read the descriptor, and so on.

For example, indeterminacy can be achieved between symbols 0 and 1, where 0 corresponds to the code word 0010000000001001, and 1 corresponds to the code word 0010000000010010 (according to one possible environment-specific implementation). Note that these code words differ in only a few bits. The descriptor printing component 108 can achieve indeterminacy by offsetting one or more lengths in the corresponding data-level regions, e.g., such that it becomes ambiguous whether the descriptor element, as a whole, is properly interpreted as a 0 or a 1.

While lengths are produced with the intent of producing indeterminacy, the purposely “incorrect” descriptor elements are as subject to manufacturing errors as any other data-level regions (e.g., in the payload data). For example, as stated above, assume that the descriptor printing component 108 produces B descriptor elements with the intent that each of the descriptor elements induces indeterminacy between the symbol “a” and symbol “b.” In actually, some of the B elements will achieve this effect. But some of the B elements may have lengths that predominantly produce an output of “a,” and others may have lengths that predominantly produce an output of

A descriptor element can be defined as a deterministic element if its interpretation is biased towards a single value. A descriptor element can be defined as a probabilistic element if its interpretation is not biased towards a single value. For example, in the above example, if the examination components (112, 132) predominately read the descriptor element associated with data-level region 504 as symbol “a,” then this descriptor element is deterministic. If, by contrast, the examination components (112, 132) read the descriptor element approximately half of the time as symbol “a” and half of the time as symbol “b,” then this descriptor element corresponds to a descriptor element that is probabilistic.

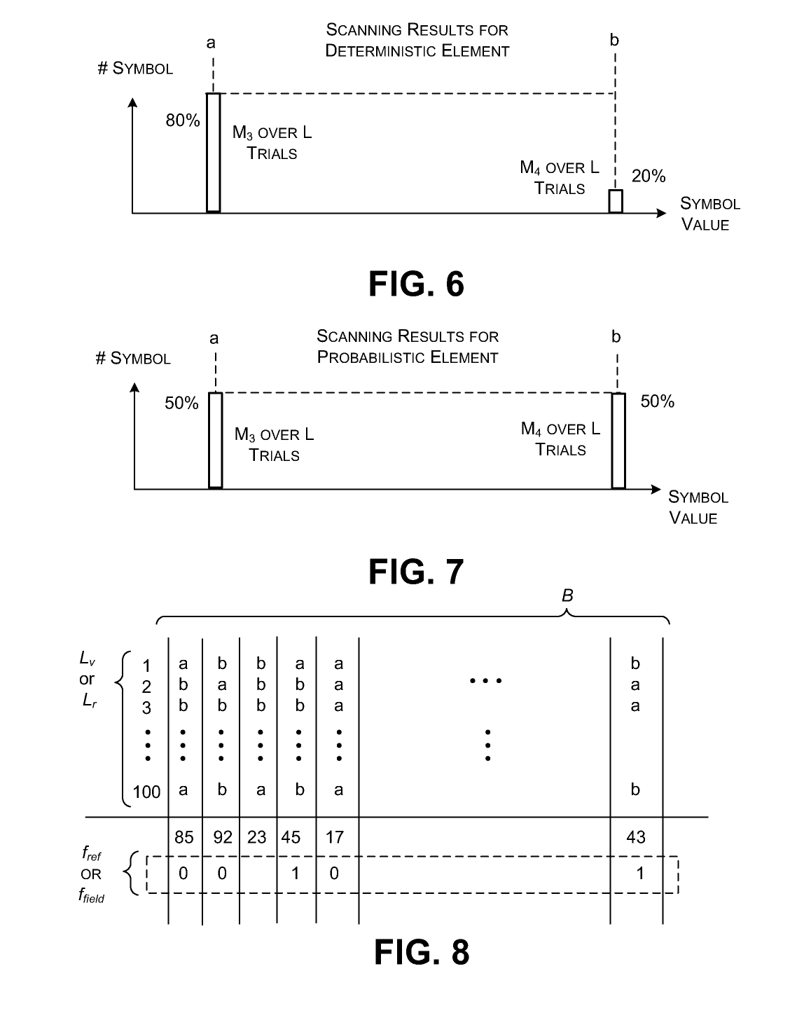

FIGS. 6 and 7 illustrate the above example in graphical form. Namely, FIG. 6 shows the result of L trials performed on a deterministic element, where 80% of the trials produce an interpretation of symbol “a”; here, the results are biased towards a single value, namely symbol “a.” FIG. 7 shows the results of L trials performed on a probabilistic element, where 50% of the trials produce an interpretation of symbol “a” and 50% of the trails produce an interpretation of symbol “b”; here, the results are not biased towards a single value.

More formally stated, a deterministic element is an element which produces a deterministic reading, as defined by M<αL or M>(1−α)L, where M refers to a number of readings for a particular value, and L corresponds to the number of trials conducted. A probabilistic element is an element which produces a probabilistic reading, as defined by αL≦M≦(1−α)L. The parameter a can be selected to classify the descriptor elements with a desired range of selectively. In one case, the same parameter a is used to create f_{ref} and, f_{field}; in another case, different parameters (αᵣ, αᵥ) are used to create f_{ref} and f_{field}, respectively.

The examination components (112, 132) leverage the above-described statistical characteristics of the descriptor elements in the following manner. First, the examination components (112, 132) read a descriptor L times. Based on the results of the readings, the examination components (112, 132) classify each element of the descriptor as either a descriptor element or a probabilistic element. The examination components (112, 132) then generate descriptor information which conveys the results of its classification of the descriptor elements.

For example, consider the examination component 112 of the creation system 110, which produces the reference descriptor information f_{ref}. The examination component 112 reads each descriptor element Lᵣ times. For each particular element, the examination component 112 determines whether this element has been consistently interpreted as a single value (in which case it is a deterministic element) or whether this element has consistently yielded inconsistent values (in which case it is a probabilistic element). The examination component 112 can then form the reference descriptor information f_{ref} as a binary-valued vector, where each element of the vector indicates whether a corresponding descriptor element is a deterministic element or a probabilistic element. FIG. 8 illustrates the formation of descriptor information in this manner, where B descriptor elements are produced with the intended effect of achieving indeterminacy between symbols “a” and “b.” Here, the descriptor elements are read 100 times and a tally is formed regarding how many times (M) that the symbol is interpreted as a particular value, e.g., either “a” or “b.” Then, this tally is converted to 1's and 0's to yield f_{ref} . The examination component 132 in the checking system 128 operates in the same manner to produce the in-field descriptor information f_{field}.

Alternatively, or in addition, the examination component 112 can form descriptive information as a multi-valued vector, where each element of the vector indicates the number of times (M) that a corresponding descriptor element has been interpreted as having a particular value. For example, for a data-level region that is designed to produce indeterminate results between symbols “a” and “b,” each element of the multi-valued vector can indicate the number of times that each corresponding descriptor element has been interpreted as symbol “a.”

The verification component 134 in the checking system 128 can compare the reference descriptor information f_{ref} with the in-field descriptor information f_{field} using any type of distance measurement. In one case, a count (np) is made of the number of probabilistic elements in f_{ref}. Another count (nₘ) is made of the number of probabilistic elements in f_{field} which match the probabilistic elements in f_{ref}. A match can be assessed to occur if nₘ/nₚ≧φ, where φ is a parameter selected to suit the objectives of a particular implementation.

The descriptor is difficult to duplicate in a counterfeiting operation. More specifically, it may be possible for a counterfeiter to successfully reproduce deterministic elements in a descriptor. But it will be much more difficult for the counterfeiter to reproduce indeterminacy-inducing probabilistic elements in an economical manner. This is because probabilistic elements occur within a narrow range of length values, which is difficult to achieve. If the manufacturing process produces a length which varies from the indeterminacy-inducing target by just a small amount, a deterministic element will be produced instead of a probabilistic element (because the interpretations of this element will predominantly favor one value over others). This, in turn, changes the fingerprint associated with the descriptor. More formally stated, because of the tight tolerances in reproducing the indeterminacy-inducing targets, the counterfeiter's manufacturing process has to exhibit a significantly lower variance compared to the original manufacturing process. It is envisioned that this goal cannot be achieved in a way that makes counterfeiting an economically feasible enterprise. The original manufacturer does not face these challenges because the reference descriptor information is created after the optical disc is manufactured; so instead of the task of matching or recreating probabilistic elements, the original manufacturer just reads the existing probabilistic elements.

Generally, the performance of the system 100 of FIG. 1 can be based on a number of parameters, any of which can be changed to suit particular objectives that apply in a particular environment. The factors include: the number (B) of descriptor elements in a descriptor; the amount of noise in the manufacturing process (which can be modeled as a Gaussian, with mean μₘ, and standard deviation σₘ); the amount of noise in the descriptor reading process at the disc creation site 104 (which can be modeled as a Gaussian, with mean μᵣ and standard deviation σᵣ); the amount of noise in the verification process (which can be modeled as a Gaussian, with mean μᵥ and standard deviation σᵥ); the number of times (Lᵣ, Lᵥ) the descriptor is read; the parameters (αᵣ, αᵥ) used to distinguish between probabilistic elements and descriptor elements; the parameter (φ) used to compare f_{ref} with f_{field}, the amount of noise in the counterfeiting process, and so on.

To repeat, while this section emphasized the use of the descriptor printing component 108 to create a descriptor with deliberately “incorrect” lengths, the principles described above can be achieved based on naturally occurring data errors, some of which correspond to deterministic elements and some of which correspond to probabilistic elements. The system 100 can look for these errors in any portion of the optical disc 102, including a portion that provides payload data.

Finally, the above explanation relates to one implementation in which the descriptor is constructed from elements having indeterminacy-inducing lengths. Other implementations can rely on other features of the optical disc 102 to produce an indeterminate interpretation when the descriptor is read.

A.3. Illustrative Authenticity Information Creation System

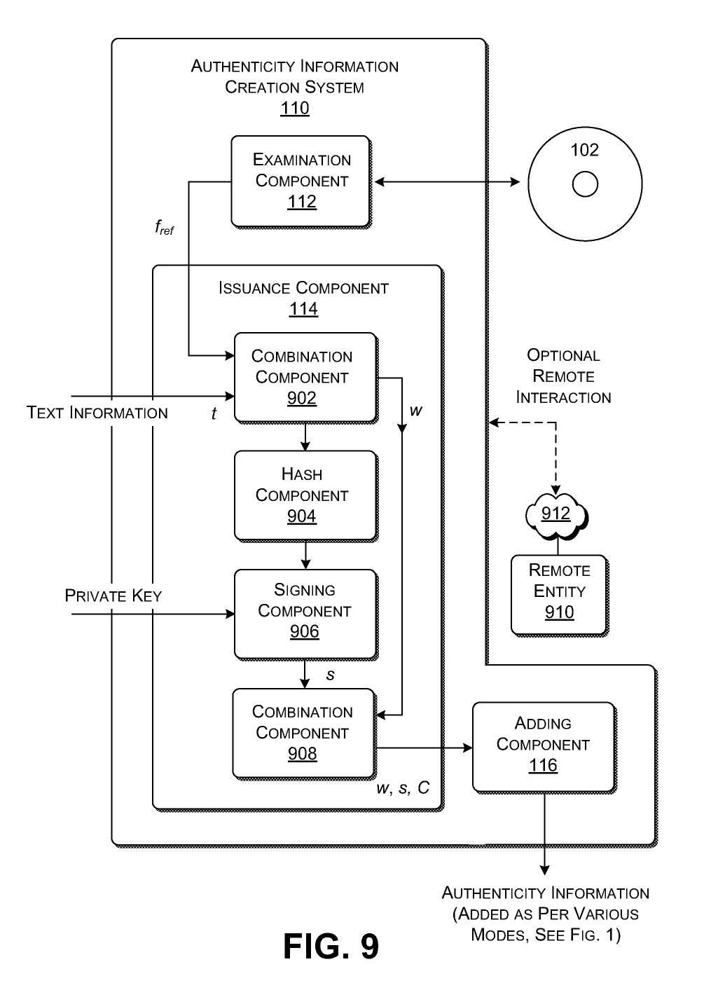

FIG. 9 shows additional details regarding the creation system 110 introduced above. To repeat the introductory explanation provided above, the examination component 112 reads the descriptor that is formed on the optical disc 102 to produce reference descriptor information (f_{ref}). The issuance component 114 can cryptographically sign the reference descriptor information to provide authenticity information. The adding component 116 makes the authenticity information available to the disc use site 106 in different ways described in Section A.1.

The issuance component 114 can perform the above-summarized signing operation in different ways. In one approach, a combination component 902 concatenates the reference descriptor information with arbitrary text. The text can provide any information that may have a bearing on the use of the optical disc 102 in a particular end-use scenario. For example, the text can provide an ID associated with the optical disc 102, an expiration date for any license associated with the optical disc 102, a list of permitted options associated with the use of the optical disc 102, a list of jurisdictions in which the optical disc 102 can be used, and so on. In short, no limitation is placed on the information that can be conveyed by the text. The collating operation performed by the combination component 902 produces a concatenated output w.

A hash component 904 optionally hashes the output of the combination component 902 to produce a hashed output. A signing component 906 signs the hashed output to provide a signed output s. In the signing operation, the hashed output can be signed with a private key associated with a publishing entity which provides the content that is encoded on the optical disc 102, or some other appropriate entity. As explained below, the signing component 906 can alternatively be implemented at another location, e.g., to more effectively maintain the secrecy of the private key.

Another combination component 908 concatenates the output w, the output s, and, optionally, a certificate. The certificate can provide a public key associated with the publishing entity and other information regarding the publishing entity. The certificate can be signed by a trusted certificate authority (CA) in a conventional manner. The concatenated output of the combination component 908 collectively constitutes authenticity information. Any component of the authenticity information can be compressed at any stage in its preparation.

The adding component 116 makes the authenticity information available to the disc use site 106 in any of the ways described in Section A.1. The authenticity information that is added to the optical disc 102 and/or the package 122 can correspond to the actual content of the authenticity information and/or a reference pointer that points to the content.

FIG. 9 also indicates that any feature of the creation system 110 can interact with any remote entity 910 via a network 912 for any purpose. For example, in one case, the creation system 100 forwards the authenticity information to the authenticity agent 124 (of FIG. 1) for storage thereat. This allows the authenticity information to be later retrieved, upon submission of an appropriate reference pointer which points to the authenticity information.

In another example of remote interaction, a software vendor or other publishing entity could decide not to disclose its signing key to a disc manufacturer. Instead, the software vendor may opt to provide a signature on demand for each disk produced by the disc manufacturer. In this approach, the disc manufacturer can generate the reference descriptor information in the manner described above and forward it to the software vendor. The software vendor (or any agent acting on its behalf) can sign the reference information and return the signed information to the disc manufacturer. This would enable the software vendor to limit the number of authentic discs that the disc manufacturer could manufacture, e.g., because the disc manufacturer is not in possession of the key and therefore cannot produce the signed information without the assistance of the software vendor.

A.4. Illustrative Descriptor Checking System

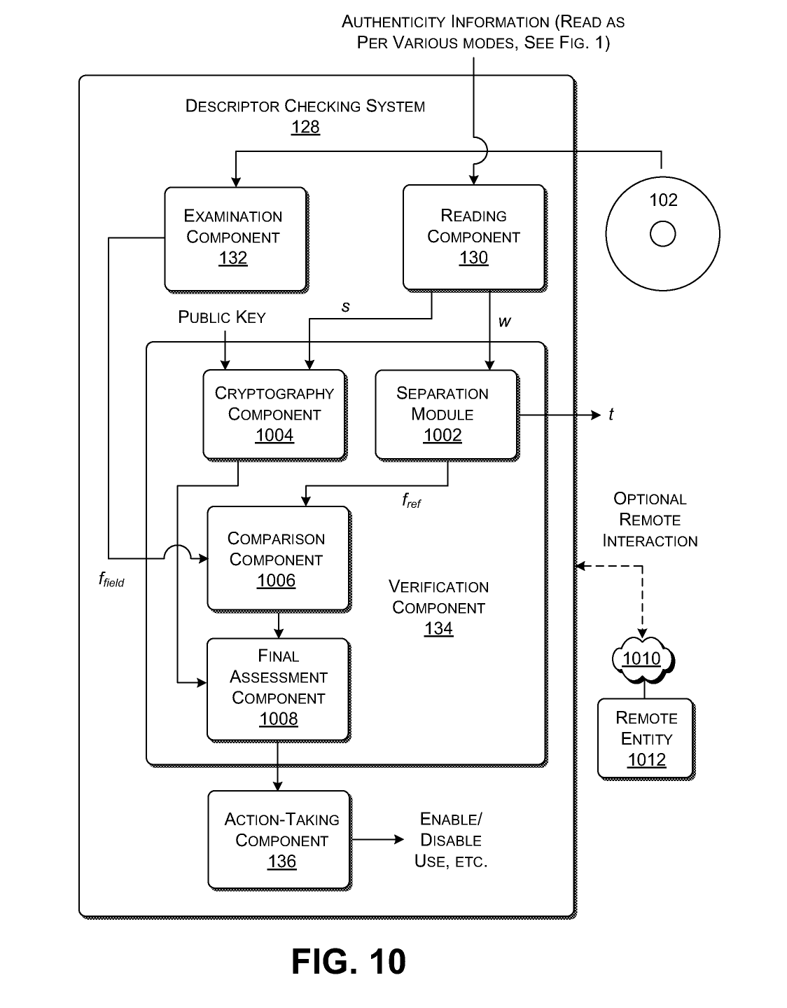

FIG. 10 shows additional details regarding the checking system 128 introduced above. To repeat the introductory explanation provided above, the code reading component 130 reads the authenticity information from an appropriate source of this information, such as the optical disc 102, its package 122, etc. The reading may comprise reading the actual content of the authenticity information and/or reading a reference pointer, from which the content can be obtained (upon accessing the authenticity agent 124 of FIG. 1). The examination component 132 reads the physical descriptor that has been added to the optical disc 102. In this context, the examination component 132 produces in-field descriptor information (f_{field}). The verification component 134 determines whether the optical disc 102 is valid based on a cryptographic test and a descriptor-validation test. The action-taking component 136 performs any type of action based on the decision made by the verification component 134.

As to the verification component 134, a separation component 1002 separates different items of information in the authenticity information. One such piece of information includes the reference descriptor information (f_{ref}) that was generated by the creation system 110. Another piece of information includes the arbitrary text.

A cryptographic component 1004 performs analysis on the authenticity information to determine whether the optical disc 102 is cryptographically valid. This analysis may involve assessing the appropriateness of the certificate provided by the trusted authority, decrypting parts of the authenticity information using the public key of the publishing entity, and so on.

A comparison component 1006 performs a descriptor-validation test to determine whether the reference descriptor information (f_{ref}) matches the in-field descriptor information (f_{field}) with an acceptable tolerance, e.g., using the equation nₘ/nₚ≧φ described above. The comparison component 1006 concludes that the descriptor that has been read is authentic if the distance satisfies the prescribed threshold criterion.

A final assessment component 1008 makes a final assessment as to the validity of the optical disc 102. That is, the final assessment component 1008 determines that the optical disc 102 is valid if it has passed both the cryptographic test of the cryptographic component 1004 and descriptor-validation test of the comparison component 1006. If either test fails, the final assessment component 1008 pronounces the optical disc 102 as invalid.

FIG. 10 also indicates that any feature of the checking system 128 can interact with any remote functionality via a network 1010 for any purpose. For example, the checking system 128 can contact the authenticity agent 124 to obtain the authenticity information, e.g., upon reading a reference pointer from the optical disc 102 or its package 122, etc.

In one approach, the checking system 128 of FIG. 10 can be implemented by modifying the control components provided by an existing optical playback device, such as a DVD player, a computer, a game console, etc. In this approach, the checking system 128 can redirect certain hardware components already provided by the device to perform new functions. This implementation may be advantageous, as it avoids costly re-engineering of hardware components provided by existing devices. Likewise, in one implementation, the creation system 110 can be implemented by modifying the control components provided by an existing device that burns content onto a recordable optical disc. In other implementations, appropriate components can be manufactured that are tailored to perform the functions described above.

A.5. Illustrative Examination Component

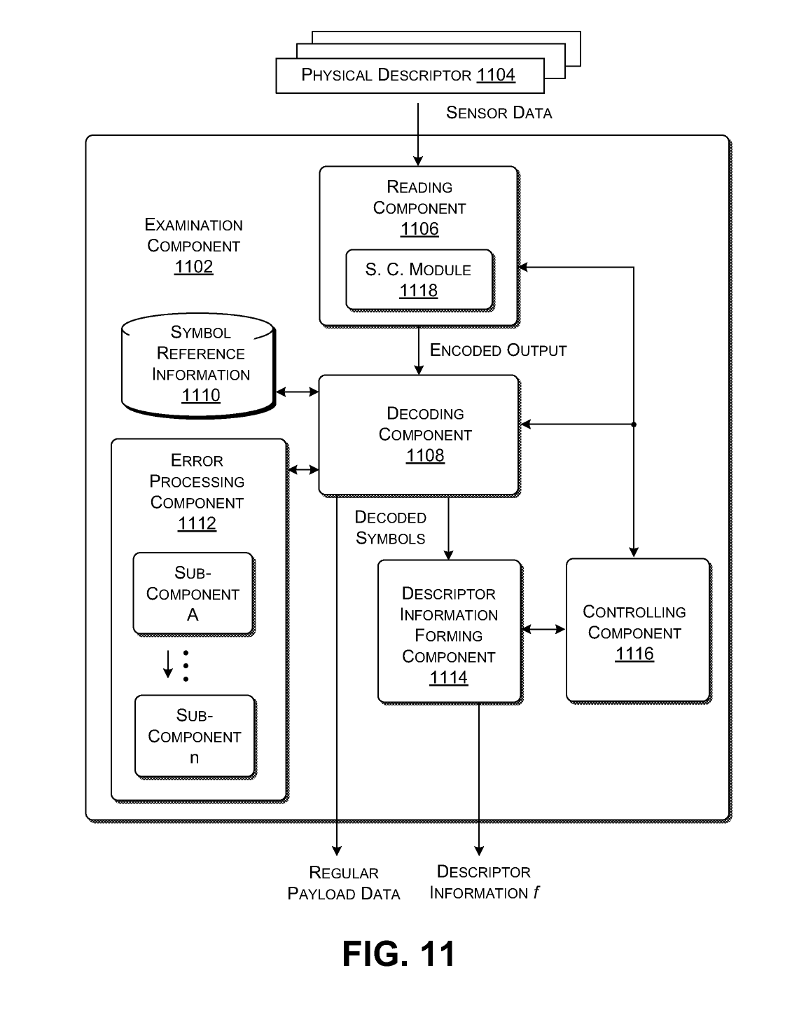

FIG. 11 provides additional details regarding the examination component 112 implemented by the creation system 110 and the examination component 132 implemented by the checking system 128. To facilitate explanation, FIG. 11 re-labels the examination components (112, 132) as examination component 1102. The main task of the examination component 1102 is to read the physical descriptor 1104 on the optical disc 102 and generate descriptor information (f_{ref} or f_{field}) based thereon.

The examination component 1102 includes a reading component 1106 for reading the descriptor. The reading component 1106 produces the encoded output shown in FIG. 5, in which data-level regions on the optical disc 102 produce high-level states and low-level states in the encoded output. The reading component 1106 can also assign 1's and 0's to the encoded output on the basis of a clock signal in the manner described above. In one particular standard, the reading component 1106 outputs 16 bit code words on the basis of its operation.

A decoding component 1108 translates the code words provided by the reading component 1106 into 8 bit symbols. In one case, the decoding component 1108 interprets the code words with reference to a store of symbol reference information 1110. The symbol reference information 1110 defines a collection of valid symbols. Any encoded output that does not have a counterpart in the symbol reference information 1110 can be deemed illegal. An error processing component 1112 attempts to correct errors in the data read from the optical disc 102. The error processing component 1112 can use any error correction algorithm or combination of error correction algorithms (e.g., associated with sub-component A, subcomponent n, etc.) to perform this function, such as any type of block-type error correction algorithm.

A descriptor information forming component 1114 (“forming component” for brevity) generates the descriptor information, e.g., either f_{ref} or f_{field}.

A controlling component 1116 controls the operation of the above-described features of the examination component 1102. For example, the controlling component 1116 can direct the examination component 1102 to read one or more descriptors on the optical disc 102 a plurality of times, e.g., Lᵣ or Lᵥ. As will be described in Section B, the controlling component 1116, in conjunction with a speed control (S. C.) component 1118, constitute functionality that can direct the examination component 1102 to read the descriptor at different playing speeds, e.g., to help offset the effects of bias in the playing speed.

The forming component 1114 operates on the decoded symbols provided by the decoding component 1108, rather than the raw 1's and 0's that are directly associated with the encoded output of the reading component 1106. Because of this intermediary relation, the decoding and error correction operations can potentially conceal meaningful low-level features in the output of the reading component 1106. The examination component 1102 is configured to reduce the occasions on which unwanted correction is performed.

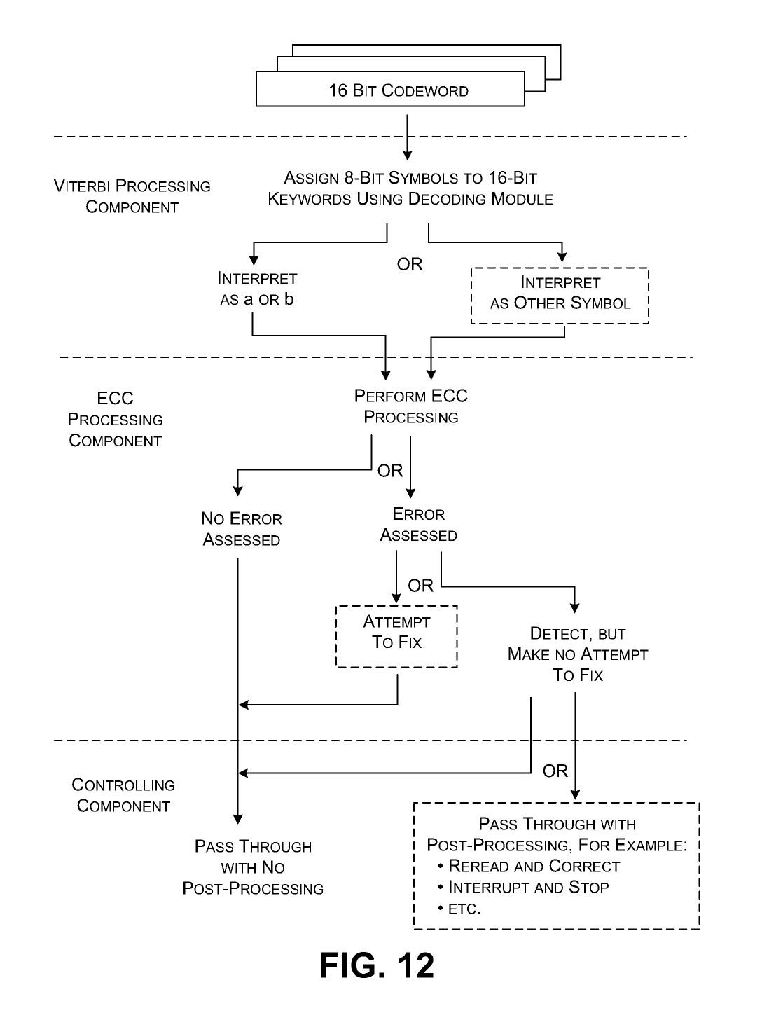

As shown in FIG. 12, in one implementation, the decoding component 1108 can apply a Viterbi processing component to interpret a stream of 16 bit keywords that are provided by the reading component 1106. Namely, the Viterbi processing component generates a stream of 8 bit symbols which reflects its interpretation of the 16 bit code words. In performing this function, the Viterbi processing component can take into the consideration the likelihood that a codewood represents each of a plurality of possible symbols, without taking into consideration state information. The Viterbi processing component can also take into account state information, reflecting the probabilities associated with different possible sequences of symbols.

An error correction (ECC) processing component (used by the error processing component 1112) operates on the output of the Viterbi processing component, e.g., using any type of block code error correction technique, such as the Reed-Solomon technique. Generally, the ECC processing component operates by analyzing the symbols that have been read from the optical disc 102 with reference to pre-stored error-checking information (also read from the optical disc 102); the ECC processing component then performs possible correction based on its analysis. At any particular instance in its processing, the ECC processing component can determine that no error is present. Or the ECC processing component can determine that an error is present, upon which it attempts to correct the error. Or the ECC processing component can determine that an error is present, but it makes no attempt to correct it (because, for instance, it may not know how to correct it).

The controlling component 1116 can take various post-solution actions based on the output of the ECC processing component. In a first case, the controlling component 1116 can determine that no action is to be performed, upon which it outputs the symbols read from the optical disc 102 without performing correction. The controlling component 1116 can perform this action when the ECC processing component indicates that the symbols are free from errors. Or the controlling component 1116 can take this action when it determines that the errors identified by the ECC processing component are acceptable (or otherwise non-actionable). In a second case, the controlling component 1116 can attempt to rectify an error, such as by re-reading the descriptor. Or the controlling component 1116 can simply abort its reading operation altogether.

As can now be appreciated, various operations performed by the examination component 1102 can have the effect of automatically “correcting” information read from the descriptor. While this is desirable in the case of reading payload data, it can interfere with the normal formation of the descriptor reference information, e.g., by biasing the statistics compiled in the descriptor reference information. This correction is therefore undesirable in some cases. In FIG. 12, possible junctures in which information can be modified are enclosed by dashed boxes. This reflects is one representative implementation; other implementations may exhibit other unwanted correction behavior.

In one implementation, the examination component 1102 can deactivate at least some of the modification operations summarized in FIG. 12, such as by deactivating the error processing component 1112 when reading the descriptor. This will prevent the examination component 1102 from correcting (and therefore concealing) meaningful low-level observations produced by the reading component 1106 (when reading the descriptor). Alternatively, or in addition, the modification operations shown in FIG. 12 are virtually turned off, rather than literally turned off For example, the system 100 can be set up such that triggering events which invoke these modifications do not occur, or occur at acceptable levels.

Generally stated, the goal of propagating relevant low-level observations to the forming component 1114 depends on the environment-specific nature of a particular implementation. In one environment, this goal can be generally achieved based on any combination of the following representative provisions.

First, the two (or more) symbols that are used to achieve indeterminacy in the interpreted output can be selected to minimize the possibility of unwanted modification. For example, some pairs of symbols may be more likely to invoke the Viterbi processing component and/or the ECC processing component, compared to other pairs of symbols. In the case of the Viterbi processing component, one goal is to provide a descriptor that, when read, produces a stream of code words that appears to have no state. In this manner, at each instance of its analysis, the decoding component 1108 will select the most likely symbol, but it will not take into account sequence information associated with different possible symbol sequences. This is desirable because this state information can potentially bias the results; further, the state information may not be useful in interpreting descriptor elements.

Second, “artificial” error-checking information can be introduced into the ECC processing component when it is reading the descriptor. This may prompt the ECC processing component to almost always determine that: (1) an error has occurred; and (2) the error cannot be corrected, and should therefore be simply passed on. This will prevent the ECC processing component from correcting errors. It does not matter that the ECC processing component “thinks” there is an error so long as no action is taken on the supposed error. In another case, “artificial” error-checking information can be injected that biases the ECC processing component to almost always determine that the symbols being read are free of errors.

Third, the controlling component 1116 can likewise be configured so that it concludes that a detected error (as assessed by the ECC processing component) is not to be corrected. This can be achieved by modifying the code that controls the operation of the controlling component 1116.

In another case, the system 100 is not set up to outright prevent all modification of symbols. Rather, the system 100 can be set up such that the decoding component 1108 and/or the error processing component 1112 interpret the code words and symbols in a manner which is predictable, and therefore can be taken into account. For example, suppose that a descriptor element is produced which achieves indeterminacy between symbols “a” and “b” when the various modifications shown in FIG. 12 are turned off When these modifications are turned on, assume that the system 100 predictably corrects symbol “b” as symbol “c,” or interprets symbol “b” as an illegal symbol, etc. So long as these interpretations are stable and predictable, then viable descriptor information (f_{ref}, f_{field}) can be constructed based thereon (because the output still indeterminately toggles between two symbols in a manner that is, overall, predictable in nature). This also applies to the case in which both “intended” symbols are corrected or interpreted as illegal symbols. This also means that is possible that two players can interpret the same descriptor as two different respective pairs of symbols, and still yield the same approximate f_{field}.

Hence, the system 100 can be configured to reduce the occurrence of unwanted modification, not necessarily all modification. Some modifications are unwanted because they are unpredictable in nature. Other modifications are predictable, yet the statistics that they produce do not match the statistics encoded by the reference descriptor information (f_{ref}); these modifications are also unwanted.

In summary, the checking system 128 forms a part of an operating environment. That operating environment is set up (e.g., through any provision or combination of provisions described above) to reduce a possibility that the examination component 132 will perform unwanted correction of symbols in a course of producing the in-field descriptor information (f_{field}).

The choice of how to configure the system 100 so that unwanted modification does not occur can be determined in an empirical manner, e.g., by investigating the behavior that different optical readers have on the interpretation of descriptors of different types. It should be noted that some of these issues arise because, in one implementation, parts of existing optical reading technology are being reconfigured to process descriptors. A reader that is specifically designed “from scratch” to process both descriptors and payload data can be designed to address these issues in a more formal way. For example, such a reader can be configured to apply separate processing functionality when processing descriptors or to automatically turn off error correction prior to reading the descriptors, e.g., in response to reading an instruction formed on the optical disc 102.

B. Illustrative Processes

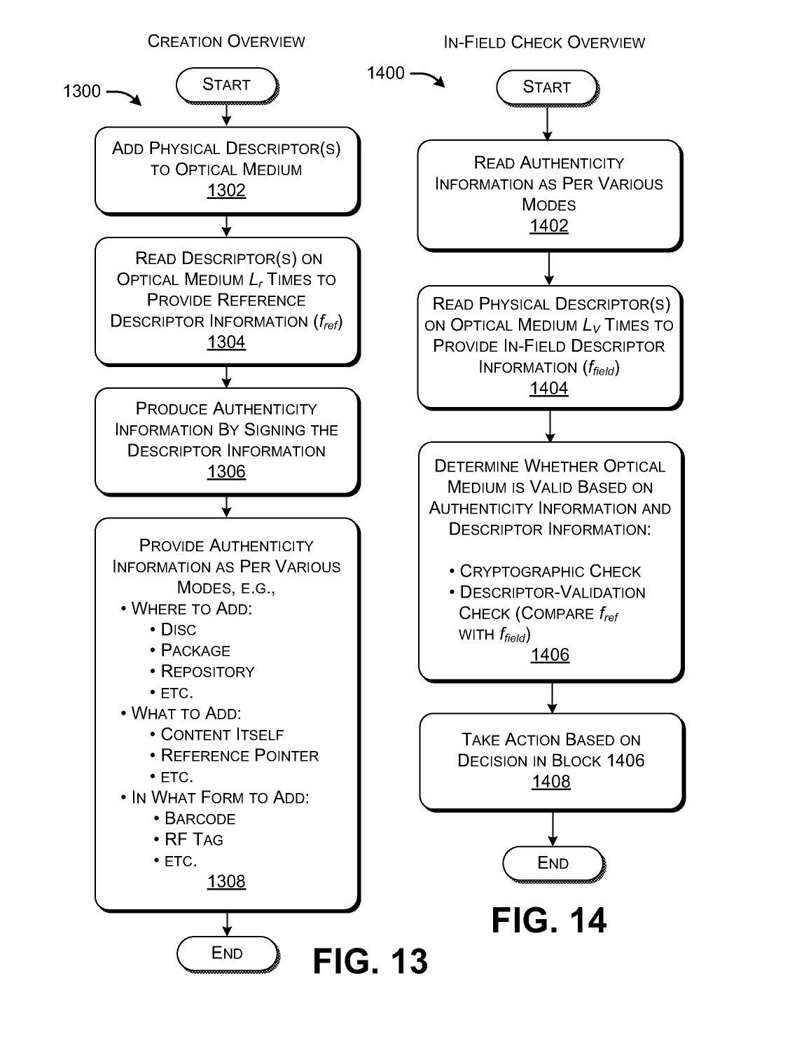

FIGS. 13-18 show procedures for implementing various aspects of the system 100. Since the principles underlying the operation of the system 100 have already been described in Section A, certain operations will be addressed in summary fashion in this section.

Starting with FIG. 13, this figure shows a procedure 1300 by which the creation system 110 can add authenticity information to the optical disc 102.

In block 1302, the descriptor printing component 108 adds one or more descriptors to the optical disc 102, e.g., in a stamping operation, a content-burning operation, etc. While plural descriptors can be added, FIG. 13 will be explained in the context of a single descriptor to facilitate discussion. In this operation, the descriptor component deliberately adds the descriptor to the optical disc 102. But this section closes with an alternative interpretation of FIG. 13, in which the descriptor is constructed from naturally-occurring indeterminacy-inducing data-level regions.

In block 1304, the creation system 110 reads the descriptor from the optical disc 102. The creation system 110 also forms reference descriptor information (f_{ref}) in the manner described above.

In block 1306, the creation system 110 signs the reference descriptor information, e.g., with a private key associated with a publishing entity or other appropriate entity. Or the reference descriptor information can be signed on behalf of the creation system 110 by another entity. This produces authenticity information according to one implementation.

In block 1308, the creation system 110 makes the authenticity information available to the disc use site 106 using any one or more of the modes described in Section A.1.

FIG. 14 shows a procedure 1400 by which the checking system 128 can retrieve and analyze authenticity information.

In block 1402, the checking system 128 reads the authenticity information from an appropriate source according to any one or more of the modes described in Section A.1.

In block 1404, the checking system 128 reads the physical descriptor from the optical disc and forms the in-field descriptor information (f_{field}).

In block 1406, the checking system 128 determines whether the optical disc 102 is valid based on a cryptographic test and a descriptor-validation test (in which f_{ref} is compared with f_{field}). In one implementation, the checking system 128 performs the cryptographic test first; the checking system 128 only performs block 1404 and advances to the descriptor-validation test if the cryptographic test passes.

In block 1408, the checking system 128 takes action based on the conclusion reached in block 1406. For example, the checking system 128 can permit or deny access to content carried by the optical disc 102. The checking system 128 can also report suspected instances of counterfeiting to appropriate entities.

The system 100 was described above in the context of the printing and reading of a single descriptor to generate a single instance of reference descriptor information f_{ref}. This approach can be extended in various ways. In another case, the descriptor printing component 108 prints two or more descriptors on the optical disc 102 within a single designated region, or possibly distributed over plural designated regions. The use of plural descriptors is potentially beneficial because it helps ensure that the checking system 128 can successfully recognize the optical disc 102 as being valid (if it is in fact valid) after undergoing the wear and tear of normal use. Matching a single descriptor at the disc use site 106 can result in the optical disc 102 being assessed as valid. In addition, or alternatively, for any descriptor, the creation system 110 forms plural items of reference descriptor information (e.g., f_{1A}, f_{1B}, f_{1C}, etc.) based on different environmental conditions or aging models (A, B, C, etc.). The formation of plural instances of f_{ref} under different conditions or models helps counteract various effects of aging. Matching any field that is computed at the disc use site 106 with any f_{ref} can result in the optical disc 102 being assessed as valid.

Finally, in the above description, the descriptor printing component 108 deliberately prints indeterminacy-inducing data-level regions. Alternatively, or in addition, the descriptor can be based, at least in part, on naturally occurring errors produced in the course of manufacturing the optical disc 102 (in a stamping process, a content-burning process, or in some other process). In this context, the descriptor printing component 108 is subsumed under the general functionality which prints the content.

The above-identified implementation can be explained by again making reference to FIG. 13. In block 1302, the operation of adding a descriptor to the optical disc 102 entails printing content on the optical disc 102. A subset of this data includes errors which can be mined to construct the descriptor. Errors can be assessed as errors based on any criteria, such as the analysis provided by the error processing component 1112. Some of these errors are deterministic in nature. These are errors which result from deterministic features (analogous to deterministic descriptor elements) on the optical disc 102 that are interpreted (upon repeated reading) in a generally consistent way. Probabilistic features (analogous to probabilistic descriptor elements) are features which result in indeterminacy during interpretation (upon repeated reading), due to naturally-occurring indeterminacy-inducing lengths.

In block 1304, the operation of reading the descriptor comprises searching the optical disc 102 for the presence of errors produced by naturally-occurring descriptor elements. The creation system 110 can construct the reference descriptor information f_{ref} based on these errors in the manner described above, where 1's and 0's are used to indicate whether a particular feature (associated with an error) produces a deterministic result or a probabilistic result. In one case, the creation system 110 searches for naturally-occurring errors over the entire content-bearing surface of the optical disc 102. In another case, the creation system 110 searches for errors over a designated content-bearing portion of the optical disc 102. Still other variations are possible. Alternatively, the reference descriptor information can also be formed from deliberately added descriptor elements formed anywhere on the optical disc 102, including portions of the optical disc 102 that contain no payload data.

In block 1404 of the checking process, the checking system 128 reads the naturally-occurring descriptor elements in the same manner described above, to thereby construct f_{field}.

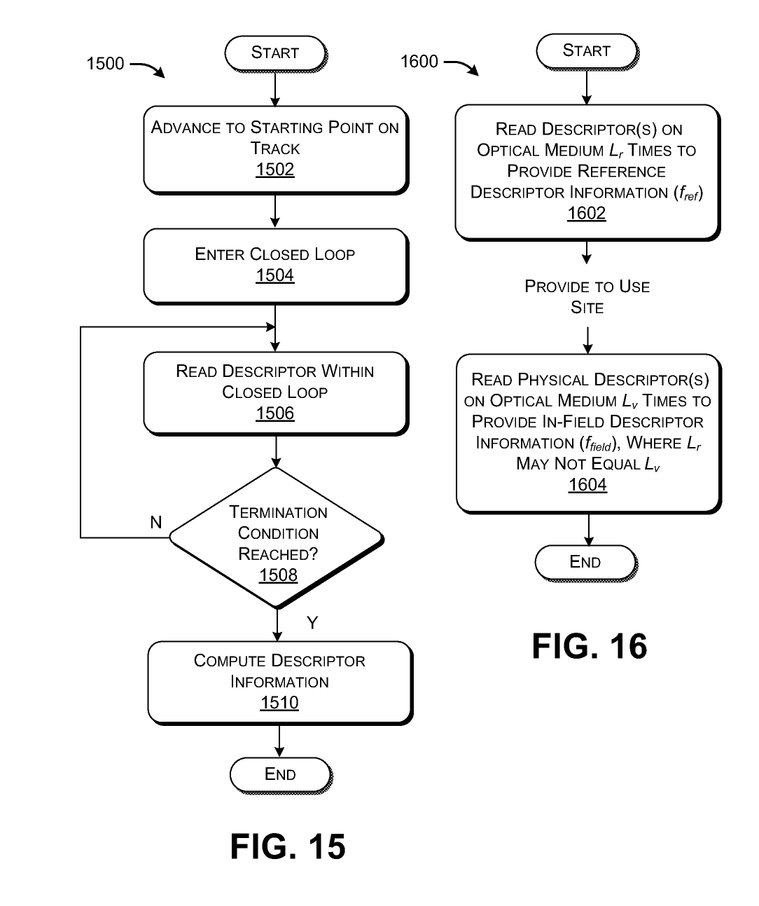

FIG. 15 shows a procedure 1500 for reading the descriptor 402 of FIG. 4. That descriptor 402 is formed on a track 406 that terminates in a closed loop 410.

In block 1502, the examination component 112 advances to the starting point 408; the starting point 408 occurs prior to the descriptor 402 (in relation to the reading operation performed by the examination component 112).

In block 1504, the examination component 112 reads the track 406 and eventually enters the closed loop 410.

In block 1506, the examination component 112 reads the descriptor 402 a first time. The feedback loop of FIG. 15 indicates that the examination component 1506 re-reads the descriptor a number of times (Lᵣ) until a termination condition is reached (as assessed in block 1508). This iterative reading operation is expedited due to the fact that the examination component 112 does not have to jump back to the starting point 408, as in the example of FIG. 3.

In block 1510, the examination component 112 forms the reference descriptor information (f_{ref}) based on the statistics compiled in block 1506.

The examination component 132 of the checking system 128 operates in the same manner described above to read the descriptor 402 Lᵥ times.

FIG. 16 shows a procedure 1600 which summarizes the reading operation performed at the disc creation site 104 and then at the disc use site 106.

In block 1602, the examination component 112 of the creation system 110 reads the descriptor Lᵣ times.

In block 1604, the examination component 132 of the checking system 128 reads the descriptor Lᵥ times. As explained above, Lᵣ may or may not equal Lᵥ. In some cases, Lᵣ<Lᵥ. In other cases, Lᵥ<Lᵣ.

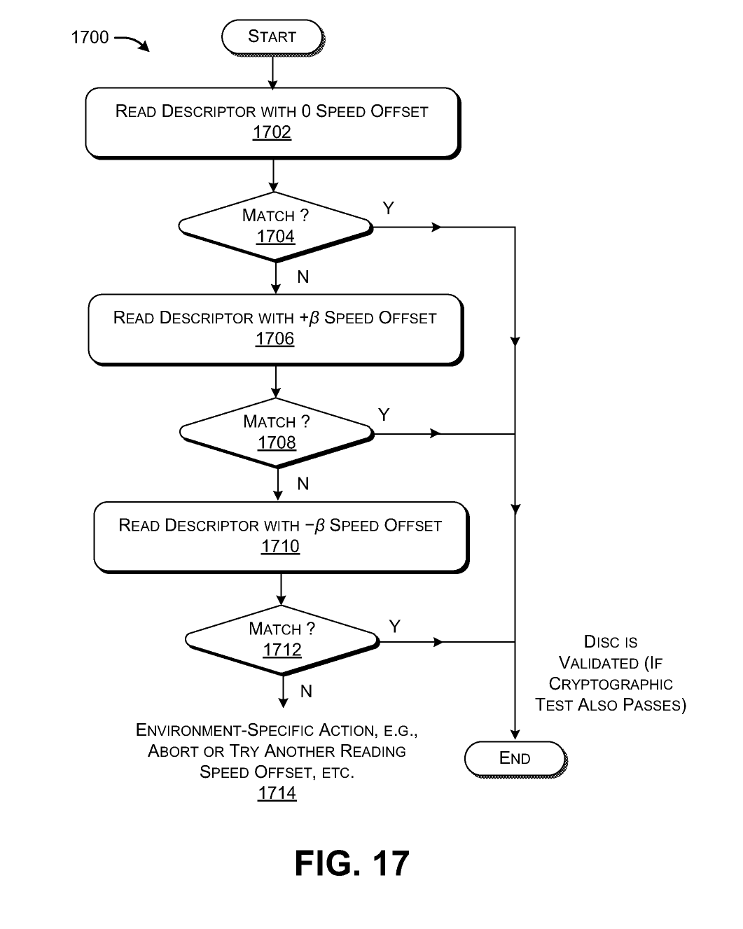

FIG. 17 shows a procedure 1700 that describes an approach for reading the descriptor at different reading speeds. A reading speed refers to a speed at which the examination component 132 of the checking system 132 reads the descriptor, e.g., as determined by a speed of rotation of the optical disc 102.

In block 1702, the examination component 132 reads the descriptor on the optical disc 102 Lᵥ₁ times at its normal playing speed, e.g., without any offset.

In block 1704, the checking system 128 checks if there is a successful match between f_{ref} and f_{field}. If so, the procedure 1700 terminates. If not, this means that either: a) the optical disc 102 is not authentic and therefore there is a proper mismatch; or b) the optical disc 102 is authentic but the examination component 132 is having a problem accurately reading the descriptor.

In block 1706, the checking system 128 investigates whether possibility (b) is true by rereading the descriptor Lᵥ₂ times at a higher playing speed, such as a playing speed that is +β% higher than its normal playing speed, e.g., in one example, a +5% speed offset. This operation will help counteract any bias in the normal playing speed of the checking system 128.

In block 1708, the checking system 128 checks whether the reading at an increased speed results in a successful match between f_{ref} and f_{field}.

In not, in block 1710, the checking system 128 rereads the descriptor Lᵥ₃ times at a lower playing speed, such as a playing speed that is −β% lower than the normal playing speed, e.g., in one example, a −5% speed offset. Again, this operation will help counteract any bias in the normal playing speed of the checking system 128.

In block 1712, the checking system 128 checks whether the reading at a decreased speed results in a successful match between f_{ref} and f_{field}.

As indicated in block 1714, the checking system 128 can take various actions upon a negative outcome in block 1712. For example, the checking system 128 can conclude that the optical disc 102 is not authentic, and thus abort. Or the checking system 128 can reread the optical disc 102 at yet other playing speed offsets. In general, FIG. 17 describes two illustrative playing speed offsets (+β and −β), but the checking system 128 can investigate any number of playing speed offsets, including playing speed offsets that are continuously increased and/or decreased over a course of a reading operation.

The reading iterations Lᵥ₁, Lᵥ₂, and Lᵥ₃ can be all the same or can differ in any way. In one case, the features of FIG. 17 can be combined with the provisions of FIG. 15 (where the descriptor is disposed on a closed loop of the optical disc 102) to accommodate the increased number of reading operations.

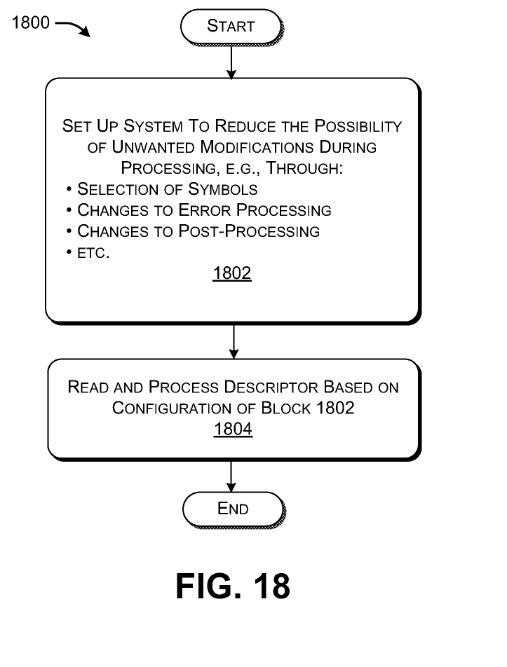

FIG. 18 shows a procedure 1800 which summarizes the explanation given above in Section A.5 with respect to FIGS. 11 and 12.

In block 1802, the environment in which the system 100 operates is set up to reduce the possibility that the examination component 1102 will perform unwanted modification of information extracted from the optical disc 102.

In block 1804, the system 100 reads and processes the descriptor based on the configuration provided in block 1802.

C. Representative Processing Functionality

FIG. 19 sets forth illustrative electrical data processing functionality 1900 that can be used to implement any aspect of the functions described above. With reference to FIG. 1, for instance, the type of processing functionality 1900 shown in FIG. 19 can be used to implement any aspect of the creation system 110, and/or any aspect of the checking system 128, and/or any aspect of the authenticity agent 124. In one case, the processing functionality 1900 may correspond to any type of computing device or optical medium player device.

The processing functionality 1900 can include volatile and non-volatile memory, such as RAM 1902 and ROM 1904, as well as one or more processing devices 1906. The processing functionality 1900 also includes various media devices 1908, such as a hard disk module, an optical disk module, and so forth. The processing functionality 1900 can perform various operations identified above when the processing device(s) 1906 executes instructions that are maintained by memory (e.g., RAM 1902, ROM 1904, or elsewhere). More generally, instructions and other information can be stored on any computer readable medium 1910, including, but not limited to, static memory storage devices, magnetic storage devices, optical storage devices, and so on. The term computer readable medium also encompasses plural storage devices.

The processing functionality 1900 also includes an input/output module 1912 for receiving various inputs from a user (via input modules 1914), and for providing various outputs to the user (via output modules). One particular output mechanism may include a presentation module 1916 and an associated graphical user interface (GUI) 1918. The processing functionality 1900 can also include one or more network interfaces 1920 for exchanging data with other devices via one or more communication conduits 1922. One or more communication buses 1924 communicatively couple the above-described components together.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for providing authenticity information associated with an optical medium to reduce counterfeit duplication of the optical medium, comprising:
adding a descriptor having plural descriptor elements to the optical medium, the descriptor being produced with an intent of providing at least one data-level region having a feature that produces indeterminate interpretations when read plural times;
reading the descriptor from the optical medium and forming reference descriptor information based on the descriptor;
producing authenticity information based on the reference descriptor information; and
providing the authenticity information for use by a verification site.

2. The method of claim 1, wherein said providing comprises providing the authenticity information as lands and pits formed on the optical medium.

3. The method of claim 1, wherein said providing comprises providing the authenticity information in a human-readable form.

4. The method of claim 1, wherein said providing comprises providing the authenticity information in a barcode form.

5. The method of claim 4, wherein the authenticity information is added in barcode form to a bust cutting area of the optical medium.

6. The method of claim 1, wherein said providing comprises providing the authenticity as an electromagnetic tag.

7. The method of claim 1, wherein said providing comprises affixing the authenticity information to the optical medium.

8. The method of claim 1, wherein said providing comprises affixing the authenticity information to an article associated with the optical medium.

9. The method of claim 1, wherein said providing comprises:
adding a reference pointer to at least one of the optical medium or to an article associated the optical medium; and
adding content associated with the authenticity information to a repository provided by an authenticity agent, the content being accessible based on the reference pointer.

10. The method of claim 1, wherein the reference descriptor information includes element type information which conveys whether each descriptor element associated with the descriptor is one of:
a deterministic element, the interpretation of which is biased towards a single value; or
a probabilistic element, the interpretation of which is not biased towards a single value.

11. An electronic descriptor checking system that forms a part of an operating environment, comprising:
a code reading component configured to read authenticity information associated with an optical medium from at least one source of authenticity information;
an examination component configured to read a descriptor from the optical medium and form in-field descriptor information based on the descriptor, the descriptor having multiple descriptor elements; and
a comparison component configured to determine whether the optical medium is valid by comparing the in-field descriptor information with reference descriptor information obtained from the authenticity information,
the environment being set up to reduce a possibility that the examination component will perform unwanted correction of symbols in a course of producing the in-field descriptor information.

12. The electronic descriptor checking system of claim 11, wherein the examination component is set up to deactivate at least one component that performs unwanted correction.

13. The electronic descriptor checking system of claim 11, wherein the environment is set up to reduce occurrence of a triggering event that will invoke unwanted correction.

14. The electronic descriptor checking system of claim 11, wherein the examination component is configured to read the descriptor Lᵥ times, and wherein the reference descriptor information is produced by reading the descriptor Lᵣ times, wherein Lᵥ does not equal Lᵣ.

15. The electronic descriptor checking system of claim 11, further including functionality for changing a playing speed at which the descriptor is read to counteract bias in the playing speed.

16. The electronic descriptor checking system of claim 11, wherein the descriptor is disposed on a track of the optical medium that forms a closed loop, and wherein the examination component is configured to read the descriptor plural times without jumping out of the closed loop.

17. The electronic descriptor checking system of claim 11, wherein the in-field descriptor information includes element type information which indicates whether each descriptor element of the descriptor is one of:
a deterministic element, the interpretation of which is biased towards a single value; or
a probabilistic element, the interpretation of which is not biased towards a single value.

18. The electronic descriptor checking system of claim 17, wherein the comparison component is configured to compare the in-field descriptor information with the reference descriptor information by computing a ratio of nₘ to nₚ, where nₚ is a number of probabilistic elements in the reference descriptor information, and nₘ is a number of probabilistic elements in the in-field descriptor information which match probabilistic elements in the reference descriptor information.

19. A method for reading a descriptor formed on an optical medium, comprising:
reading a descriptor that has been added to the optical medium Lᵣ times and forming reference descriptor information based on the descriptor, the descriptor being produced with an intent of providing at least one data-level region having a length that produces indeterminate interpretations when read plural times; and
at a verification site, reading the descriptor Lᵥ times and forming in-field reference descriptor information based on the descriptor,
where Lᵣ does not equal Lᵥ.

20. The method of claim 19, further comprising, at the verification site, reading the descriptor using at least one offset speed if a reading at a normal speed does not produce a match between the reference descriptor information and the in-field descriptor information.
